(19) United States
(12) Patent Application Publication
(10) Pub. No.: US 2008/0287568 A1
(43) Pub. Date: Nov. 20, 2008

(54) Polyolefin Drag Reducing Agents Produced by Non-Cryogenic Grinding

(75) Inventors: Thomas Mathew, Tulsa, OK (US); Nagesh S. Kommareddi, Broken Arrow, OK (US)

Correspondence Address: MADAN, MOSSMAN & SRIRAM, P.C., 2603 AUGUSTA DRIVE, SUITE 700, HOUSTON, TX, 77057-5662, US

(73) Assignee: BAKER HUGHES INCORPORATED, Houston, TX (US)

(21) Appl. No.: 11/748,103

(22) Filed: May 14, 2007

(51) Int. Cl. C08J 3/12

(52) U.S. Cl. 523/175; 137/13; 241/15; 241/29; 524/379

(57) ABSTRACT

Fine particulate polymer drag reducing agent (DRA) in bi-modal or multi-modal particle size distributions may be produced simply and efficiently without cryogenic temperatures. The grinding or pulverizing of polymer, such as poly(alpha-olefin) suitable for reducing drag in flowing hydrocarbons may be achieved by the use of at least one liquid grinding aid and at least two grinding processors in series. The impellers of the grinders are of different openness so that granulated polymer fed to the first processor having a relatively more open impeller is ground to an intermediate size which is fed to the second processor having a relatively more closed impeller which grinds the polymer to a second, smaller size. A non-limiting example of a suitable liquid grinding aid includes a blend of propylene glycol, water and hexanol. Particulate DRA may be produced at a size of about 300 microns or less in only two passes.

### TECHNICAL FIELD

The invention relates to processes for producing polymeric drag reducing agents in a finely divided particulate form, and most particularly to processes for grinding polymeric drag reducing agents to produce fine particulates thereof in two or more passes that do not require grinding at cryogenic temperatures.

### BACKGROUND

The use of polyalpha-olefins or copolymers thereof to reduce the drag of a hydrocarbon flowing through a conduit, and hence the energy requirements for such fluid hydrocarbon transportation, is well known. These drag reducing agents or DRAs have taken various forms in the past, including slurries or dispersions of ground polymers to form free-flowing and pumpable mixtures in liquid media. A problem generally experienced with simply grinding the polyalpha-olefins (PAOs) is that the particles will “cold flow” or stick together after the passage of time, thus making it impossible to place the PAO in the hydrocarbon liquid where drag is to be reduced, in a form of suitable surface area, thus particle size, that will dissolve or otherwise mix with the hydrocarbon in an efficient manner. Further, the grinding process or mechanical work employed in size reduction tends to degrade the polymer, thereby reducing the drag reduction efficiency of the polymer.

One common solution to preventing cold flow during the grinding process is to coat the ground polymer particles with an anti-agglomerating agent. Cryogenic grinding of the polymers to produce the particles prior to or simultaneously with coating with an anti-agglomerating agent has also been used. However, some powdered or particulate DRA slurries require special equipment for preparation, storage and injection into a conduit to ensure that the DRA is completely dissolved in the hydrocarbon stream. The formulation science that provides a dispersion of suitable stability that it will remain in a pumpable form necessitates this special equipment.

Gel or solution DRAs (those polymers essentially being in a viscous solution with hydrocarbon solvent) have also been tried in the past. However, these drag reducing gels also demand specialized injection equipment, as well as pressurized delivery systems. The gels or the solution DRAs are stable and have a defined set of conditions that have to be met by mechanical equipment to pump them, including, but not necessarily limited to viscosity, vapor pressure, undesirable degradation due to shear, etc. The gel or solution DRAs are also limited to about 10% activity of polymer as a maximum concentration in a carrier fluid due to the high solution viscosity of these DRAs. Thus, transportation costs of these DRAs are considerable, since up to about 90% of the volume being transported and handled is inert material.

From reviewing the many prior patents in this field it can be appreciated that considerable resources have been spent on both chemical and physical techniques for easily and effectively delivering drag reducing agents to the fluid that will have its friction reduced. Yet none of these prior methods has proven entirely satisfactory. For instance, in conventional non-cryogenic grinding processes multiple passes through the grinder, on the order of 30 passes or runs, are necessary to reduce the particle size sufficiently. Thus, there needs to be a more efficient process of size reduction.

Thus, it would be desirable if a drag reducing agent could be developed which rapidly dissolves in the flowing hydrocarbon (or other fluid), which could minimize or eliminate the need for special equipment for preparation and incorporation into the hydrocarbon at the site of the fluid, and which could be formulated to contain greater than 10% polymer to reduce storage and transportation of inert material. It would also be desirable to have a process for producing particulate drag reducing agent that did not require cryogenic grinding in its preparation and/or only grinding under ambient temperature conditions in as few passes or runs as possible.

### SUMMARY

There is provided, in one form, a method for producing a particulate polymer drag reducing agent that involves feeding to a first processor components that include granulated polyolefin and at least one liquid grinding aid. The components are ground to produce intermediate particulate polyolefin drag reducing agent of a first size, which in turn is fed to a second processor. These intermediate particulate polyolefin drag reducing agent of a first size are then ground to produce particulate polyolefin drag reducing agent of a second size smaller than the first size. This process can be repeated through multiple processors to continually and further reduce the size of the particulate polyolefin. This method is highly efficient in reducing the particle size of the polymer compared to previous wet granulation methods, and also provides a simple way of producing bi-modal and multi-modal particle size distributions.

Optionally, the processors each have impellers, where the impeller of the first processor is relatively more open than the impeller of the second processor. In another non-limiting embodiment the grinding is conducted in the absence of cryogenic temperatures.

In another alternate embodiment, the intermediate (first) size of the particulate polyolefin drag reducing agent is between about 550 to about 450 microns, where the second size is from about 200 to about 300 microns. The choice of impeller and grinding head combinations for further processing can be adjusted to reach the desired size for the particulate polyolefin.

### DETAILED DESCRIPTION

Prior processes for reducing the size of polymer drag reducing agents (DRAs) have involved multiple passes or runs through a grinder, recycling the material up to as much as 30 times to achieve sufficient size reduction. This is inefficient. Secondly, it is desirable to have an efficient and simple way of producing bi-modal and multi-modal particle size distributions. Bi-modal and multi-modal particle size distributions can be very important to DRA product performance in pipelines. A bimodal particle size distribution is one that includes two different particle size distributions that have peaks at different sizes, whereas multi-modal refers to a combination of more than two different particle size distributions. Bi-modal or multi-modal particle size distributions that have the desired distributions have generally not been made simply or efficiently, before now.

A process has been discovered by which only two grinders or processors, or more than two grinders or processors, in series may be utilized in combination with a liquid grinding aid to render a granulated polyolefin polymer into a ground state of fine particles of about 300 microns or less at non-cryogenic conditions in only two passes, in one non-limiting embodiment (one pass in each grinder or processor). The process in one non-limiting embodiment involves the introduction of atomized, injected or otherwise applied liquid grinding aid (composed of wetting properties such that lubricity is imparted to the grinding system) optionally in unison with the introduction of an organic solid grinding aid into the grinding chamber such that particle agglomeration and gel ball formation of soft polyolefins is minimized or prevented. The solid grinding aid may also be used to improve the shearing action helpful in the grinding or pulverizing chamber to achieve the small polymer particles of about 600 microns or less (intermediate stage) or 300 microns or less (second stage). Use of a single liquid grinding aid such as the wetting agent, and passing the polymer through two processors or grinders in series with different sized blades produces particle sizes on the order of about 200-300 microns.

In one non-limiting embodiment, the grinding for producing particulate polymer drag reducing agent is conducted at non-cryogenic temperatures. For the purposes herein, cryogenic temperature is defined as the glass transition temperature (T_{g}) of the particular polymer having its size reduced or being ground, or below that temperature. It will be appreciated that T_{g} will vary with the specific polymer being ground. Typically, T_{g} ranges between about −10° C. and about −100° C. (about 14° F. and about −148° F.), in one non-limiting embodiment. In another non-restrictive version, the grinding for producing particulate polymer drag reducing agent is conducted at ambient temperature. For the purposes herein, ambient temperature conditions are defined as between about 20-25° C. (about 68-77° F.). In an alternate non-limiting embodiment, ambient temperature is defined as the temperature at which grinding occurs without any added cooling. Because heat is generated in the grinding process, “ambient temperature” may thus in some contexts mean a temperature greater than about 20-25° C. (about 68-77° F.). In still another non-limiting version herein, the grinding to produce particulate polymer drag reducing agent is conducted at a chilled temperature that is less than ambient temperature, but that is greater than cryogenic temperature for the specific polymer being ground. A preferred chilled temperature may range from about −7 to about 2° C. (about 20 to about 35° F.).

If the liquid grinding aid is added in small quantities, then the action of the liquid is not so much to aid in the shearing mechanism, but rather to aid in the lubricity of the pulverizing system such that hot spots due to mechanical shear are greatly reduced or eliminated. As noted, some rise in temperature is expected with any grinding. Also, without the addition of the liquid grinding aid in small quantities, rubbery polymer tends to build up on pulverizing blade surfaces. Again, lubricity of the system plays an important role in maintaining an efficient grinding operation; an efficient system as defined by a smooth flowing pulverizing operation with little polymer build-up on metal surfaces, lack of gel ball formation, and in conjunction with suitable production rates. Suitable production rates include, but are not necessarily limited to, a minimum of about 2 to an upper rate of about 6 gallons per minute (about 7.6 to about 23 liters/min.).

Generally, the polymer that is processed in the methods herein may be any conventional or well known polymeric drag reducing agent (DRA) including, but not necessarily limited to, poly(alpha-olefin), polychloroprene, vinyl acetate polymers and copolymers, poly(alkylene oxide), and mixtures thereof and the like. For the methods to be successful, the polymeric DRA would have to be of sufficient structure (molecular weight) to exist as a neat solid which would lend itself to the pulverizing process, i.e. that of being sheared by mechanical forces to smaller particles. A DRA of a harder, solid nature (relatively higher glass transition temperature) than poly(alpha-olefin) would certainly work.

Further details about continuously polymerizing DRA polymers may be found in U.S. Pat Nos. 6,649,670 and 7,119,132, both incorporated by reference herein in their entirety. Patent documents involving granulation using liquid grinding aids include U.S. Pat. Nos. 6,894,088 and 6,946,500 and U.S. Patent Application Publication No 2007/0066712 A1, all incorporated by reference herein in their entirety.

Poly(alpha-olefin) is a preferred polymer in one non-limiting embodiment herein. Poly(alpha-olefins) (PAOs) are useful to reduce drag and friction losses in flowing hydrocarbon pipelines and conduits. Prior to the innovative processes and methods described herein, the polymer has already been granulated, such as by any of the previously noted techniques or other processes, that is, broken up or otherwise fragmented into granules of about 0.5 inch (1.3 cm) or less, alternatively in the range of about 6 mm to about 20 mm, or in another non-limiting embodiment from a lower threshold of about 8 mm independently up to about 12 mm. It is permissible for the granulated polymer to have an anti-agglomeration agent thereon. Such anti-agglomeration agents include, but are not necessarily limited to talc, alumina, magnesium stearate, ethylene bis-stearamide, and the like and mixtures thereof, and others known in the art.

Within the context of methods and processes herein, the term “granulate” refers to any size reduction process that produces a product that is relatively larger than that produced by grinding. Further within the context of these methods, “grinding” refers to a size reduction process that gives a product relatively smaller than that produced by “granulation”. “Grinding” may refer to any milling, pulverization, attrition, homogenization, or other size reduction that results in particulate polymer drag reducing agents of the size and type that are the goal herein.

The solid organic grinding aid may be any finely divided particulate or powder that inhibits, discourages or prevents particle agglomeration and/or gel ball formation during grinding. The solid organic grinding aid may also function to provide the shearing action necessary in the pulverizing or grinding step to achieve polymer particles of the desired size. The solid organic grinding aid itself has a particle size, which in one non-limiting embodiment ranges from about 1 to about 300 microns, preferably from about 10 to about 50 microns. Suitable solid organic grinding aids include, but are not necessarily limited to, ethene/butene copolymer (such as Microthene, available from Equistar, Houston), paraffin waxes (such as those produced by Baker Petrolite), solid, high molecular weight alcohols (such as Unilin alcohols available from Baker Petrolite), and any non-metallic, solid compounds composed of C and H, and optionally N and/or S which can be prepared in particle sizes of 10-50 microns suitable for this process, and mixtures thereof. Ethylene bis-stearamide is effective as a solid, organic grinding aid also.

The liquid grinding aid provides lubricity to the system during grinding. Suitable liquid grinding aids include any which impart lubricity to the surface of the polymer being ground. Specific examples include, but are not necessarily limited to, a blend of a glycol with water and/or an alcohol. Suitable glycols include, but are not necessarily limited to, ethylene glycol, propylene glycol, diethylene glycol, dipropylene glycol, methyl ethers of such glycols, and the like, and mixtures thereof. Suitable alcoholic liquids include, but are not necessarily limited to, methanol, ethanol, butanol, isopropanol (isopropyl alcohol, IPA), hexanol, heptanol, octanol and the like and mixtures thereof. Liquid grinding aids that are non-harmful to the environment are particularly desirable. In one non-limiting embodiment herein, the liquid grinding aid is the blend of propylene glycol, water and hexanol. The proportions of the three components in this blend may range from about 20 to 80 wt. % to about 20 to 80 wt. % to about 0 to 30 wt. %, preferably from about 20 to 80 wt. % to about 20 to 80 wt. % to about 0 to 20 wt. %. In one non-limiting embodiment herein, the liquid grinding aid is atomized or sprayed into the grinding or pulverizing chamber and/or onto the polymer granules as they are fed to the chamber.

It will be appreciated that there will be a number of different specific ways in which the methods may be practiced that are within the scope of the invention, but that are not specifically described herein. For instance, in one non-limiting embodiment herein, the granulated polymer is fed into the grinding chamber of the processors at a rate of from about 210 to about 660 lbs/hr (about 95 to about 300 kg/hr), the optional solid organic grinding aid is fed at a rate of from about 60 to about 180 lb/hr, and the liquid grinding aid is fed at a rate of from about 600 to about 1680 lbs/hr (about 272 to about 762 kg/hr). As noted, all of the components may be fed simultaneously to the grinding chamber. Alternatively, the components may be mixed together prior to being fed to the grinding chamber. In an alternate version herein, the components are added sequentially, in no particular order or sequence. In one non-restrictive version, the liquid grinding aid and optional solid grinding aid are added only to the first processor, but in another non-limiting embodiment may be added to any of the sequential processors.

In another non-restrictive embodiment herein, the method uses an advanced rotor/stator combination in two or more stages or passes in series. This is a very efficient reduction process for producing polymer particles compared to existing conventional grinding processes, particularly those that recycle the polymer particulates ten, twenty or thirty times to achieve the desired size. Suitable rotor/stator equipment for the methods herein include, but are not limited to, COMITROL® processors available from URSCHEL® Laboratories. The stator has multiple removable blades on the periphery of a microcut head. An impeller on a rotor forces the polymer granules into the cutting stator blades. These blades may be removed and reversed, thereby extending the life of the stator. The rotor may have a uni-cut or veri-cut impeller based on the particle size of the feed to the grinder or processor. Veri-cut impellers are more open and are used for coarse cutting; that is, to produce a larger, coarser particle. Uni-cut impellers are more closed and are used for finer grinding. In the methods herein, a first processor having a veri-cut impeller would grind the granulated polymer to an intermediate polymer particle of a first or intermediate size, which would be fed to a second processor in series with the first processor, where the second processor had a uni-cut impeller to grind the intermediate polymer to a final or second size smaller than the first size. Generally, the first impeller is relatively more open than the second impeller. In one non-limiting embodiment, the impeller of the first processor is semi-open and the impeller of the second processor is closed. Open, semi-open and closed impellers are well known in the art. In a non-restrictive alternative, the first processor and second processor each have blades, where the blades of the second processor are smaller than the blades of the first processor. Similarly, subsequent processors, if employed, would have incrementally different blades to achieve a still more reduced size. For instance, the blades on a subsequent processor would be smaller and/or more closed blades relative to the immediate previous processor.

The blades on the microcut head of these processors may be arranged or oriented at an angle to provide maximum cutting efficiency. In another non-limiting embodiment, the grinding edges may be coated with tungsten carbide to eliminate, reduce or mitigate wear. With properly selected grinding heads, the polymer particle size may be reduced to the 200-300 micron range in two passes (one pass each per processor in series). In earlier grinding technology for PAO applications, multiple passes were required (e.g. approximately 30 passes or runs) to get the same particle size reduction. Furthermore, such prior methods of repeated recycling of the particulate polymer back through the same machine ultimately produced particles of only one particle size distribution. On these conventional machines, the polymer particles were recycled through the same machine until the desired particle size was achieved.

In the methods herein, two different processors or grinders with different cutting blades are used in series and the material is not normally recycled to achieve the smaller sizes. In an alternate, non-limiting embodiment, optional recycling of some of the particles may be performed to achieve a final polymer particle product that has a desired bi-modal or multi-modal size distribution. Bi-modal and/or multi-modal size distributions are important in the dissolution of DRA polymers in a flowing hydrocarbon in a pipeline because the smaller particles will dissolve and become effective first and the larger particles will last until further down the pipeline flow to continue to provide drag reduction to the hydrocarbon stream. More information about bi-modal or multi-modal size distributions for DRAs may be found in U.S. Patent Application Publication No. 2006/0293196 A1 (Ser. No. 11/451,741) incorporated herein by reference in its entirety. A bi-modal particle size distribution may also be achieved by not feeding all of the intermediate particulate polyolefin from the first processor to the second processor for further grinding. The diverted intermediate particulate polyolefin DRA would then be combined with at least part of the final particulate polyolefin DRA of reduced size from the second processor to form the final DRA product. This novel concept can be extended out to multi-modal particle size distributions of polyolefin DRA, utilizing multiple processors.

In another non-limiting embodiment, two or more grinders or processors may be stacked on top of one another, that is, vertically one over the other. This orientation or configuration will reduce the overall footprint and enable processing sequential and/or multiple passes through the same machine, for instance recycling the particles back to one or both of the processors or grinders.

One non-restrictive embodiment will have the size of the intermediate particulate polymer from the first processor be between about 550 to about 450 microns, alternatively the lower end of this range may independently be about 475 microns and the upper end of this range may independently be about 525 microns. In one non-limiting embodiment, it is expected that the processes described herein will produce particulate polymer drag reducing agent product where the average particle size ranges from about 200-300 microns, alternatively where at least 90 wt % of the particles have a size of less than about 300 microns or less, in another alternate version 100 wt. percent of the particles have a size of 250 microns or less.

It is expected that the resulting particulate polymer DRAs may be easily transported in the form of a particulate dispersion in liquid as contrasted with a powdery product. The liquid in the dispersion may be the liquid grinding aid, together with additional materials added after the finished product is formed (e.g. any of the previously mentioned liquids suitable as the liquid grinding aid or other compatible liquids that are non-solvents for the polymer DRA). The particulate polymer DRAs may be readily inserted into and incorporated within a flowing hydrocarbon, aqueous fluid, oil-in-water emulsion or water-in-oil emulsion, as appropriate. DRA products made by the processes and methods herein are free-flowing and contain a high percentage, up to about 50% of active polymer, alternatively from about 10-40% of active polymer.

The invention will now be further described with respect to specific examples that are provided only to further illustrate the invention and not limit it in any way.

### EXAMPLES 1-4

Grinding of polyolefin polymer for DRA particles was conducted in a two-pass process, one pass sequentially each through two processors or grinders where the impeller of the first processor was semi-open and the impeller of the second processor was closed. The following data were developed.

### Example #1

Particle size (mv) 259 microns
Particle size (D95) 493 microns

### Example #2

Particle size (mv): 197 microns
Particle size (D95): 360 microns

### Example #3

Particle size (mv): 268 microns
Particle size (D95): 497 microns

### Example #4

Particle size (mv): 249 microns
Particle size (D95): 425 microns

“MV” refers to the mean diameter of the volume distribution and represents the center of gravity of the particle size distribution curve. The particle size given first is the final particle size after the second pass, where “D95” refers to about 95% of the particles being at or below this size. The intermediate particle sizes are given second. The initial particle size is 8 mm-12.7 mm on the polymer granules. It may be seen that polyolefin DRA particles of 300 microns or less may be achieved in the two-pass method herein.

An efficient process for producing a bi-modal or multi-modal, particulate polymer drag reducing agent of suitable small particle size and adequate surface area in two passes, one each sequentially through different grinders or processors, which will readily dissolve and dissipate in flowing hydrocarbon streams has been provided. These particulate polymer DRAs may be simply and readily manufactured and do not require cryogenic temperatures to be produced. These bi-modal or multi-modal polymer particulates do not require multiple recycling of the particles to the same machine, e.g. on the order of 10, 20 or 30 recycle passes. These particulate polymer DRAs do not cold flow upon standing once they are made.

Many modifications may be made in the composition and process of this invention without departing from the spirit and scope thereof that are defined only in the appended claims. For example, the exact nature of and proportions of polymer, processors or grinders, optional solid organic grinding aid, and liquid grinding aid may be different from those used here. Particular processing techniques may be developed to enable the components to be homogeneously blended and work together well, yet still be within the scope of the invention. Additionally, feed rates of the various components are expected to be optimized for each type of grinding equipment and for each combination of components (e.g. polymer and liquid grinding aid) employed.

What is claimed is:

1. A method for producing a particulate polymer drag reducing agent, comprising:
feeding to a first processor components comprising:
granulated polyolefin; and
at least one liquid grinding aid;
grinding the components to produce intermediate particulate polyolefin drag reducing agent of a first size;
feeding to a second processor the intermediate particulate polyolefin drag reducing agent of a first size; and
grinding the components to produce the particulate polyolefin drag reducing agent of a second size smaller than the first size.

2. The method of claim 1 where the first processor and the second processor have impellers, and the impeller of the first processor is more open than the impeller of the second processor.

3. The method of claim 1 where the grinding by both processors is conducted in the absence of cryogenic temperatures.

4. The method of claim 1 where the processors each grind the polyolefin using a combination of at least one rotor and at least one stator.

5. The method of claim 1 where particulate polyolefin drag reducing agent is not recycled to either processor.

6. The method of claim 1 where in the feeding, the granulated polymer has an average diameter of 0.5 inch (1.3 cm) or less.

7. The method of claim 1 where the first size of the intermediate particulate polyolefin drag reducing agent is an average particle size between about 550 to about 450 microns.

8. The method of claim 1 where the second size of the particulate polyolefin drag reducing agent is an average particle size ranging from about 200 to about 300 microns.

9. The method of claim 1 where the liquid grinding aid is selected from the group consisting of a blend of at least one glycol selected from the group consisting of ethylene glycol, propylene glycol, diethylene glycol, dipropylene glycol, methyl ethers of such glycols, and mixtures thereof, and at least one other liquid selected from the group consisting of water and at least one alcohol, the alcohol being selected from the group consisting of methanol, ethanol, butanol, isopropanol, hexanol, heptanol, octanol and mixtures thereof.

10. The method of claim 1 where the liquid grinding aid is a blend of propylene glycol, water and hexanol where the proportions range from about 20 to 80 wt. % to about 20 to 80 wt. % to about 0 to 30 wt. %.

11. The method of claim 1 where in the feeding, the granulated polymer is fed at a rate of from about 210 to about 660 lbs/hr (about 95 to about 300 kg/hr) and the liquid grinding aid is fed at a rate of from about 600 to about 1680 lbs/hr (about 272 to about 762 kg/hr).

12. The method of claim 1 where the two processors are oriented vertically one over the other.

13. The method of claim 1 where not all of the intermediate particulate polyolefin drag reducing agent of a first size from the first processor is fed to the second processor, and at least part of the diverted intermediate particulate polyolefin drag reducing agent of a first size is combined with at least part of the particulate polyolefin drag reducing agent of a second size to give a bi-modal or multi-modal drag reducing agent product.

14. The method of claim 1 further comprising feeding the particulate polyolefin drag reducing agent to at least one subsequent processor and grinding the particulate polyolefin drag reducing agent to a third size smaller than the second size.

15. The method of claim 1 further consisting essentially of only the two feeding and two grinding operations in the absence of any subsequent grinding operations.

16. The method of claim 1 further comprising feeding a solid grinding aid to the first processor.

17. A method for producing a particulate polymer drag reducing agent, comprising:
feeding to a first processor components comprising:
granulated polyolefin; and
at least one liquid grinding aid, where the first processor has an impeller; and
grinding the components to produce intermediate particulate polyolefin drag reducing agent of a first size;
feeding to a second processor the intermediate particulate polyolefin drag reducing agent of a first size, where the second processor has an impeller where the impeller of the first processor is more open than the impeller of the second processor; and
grinding the components to produce the particulate polyolefin drag reducing agent of a second size smaller than the first size,
where the grinding by both processors is conducted in the absence of cryogenic temperatures.

18. The method of claim 17 where the processors each grind the polyolefin using a combination of at least one rotor having the blades and at least one stator.

19. The method of claim 17 where particulate polyolefin drag reducing agent is not recycled to either processor.

20. The method of claim 17 where in the feeding, the granulated polymer has an average diameter of 0.5 inch (1.3 cm) or less, the first size of the intermediate particulate polyolefin drag reducing agent is an average particle size between about 550 to about 450 microns, and the second size of the particulate polyolefin drag reducing agent is an average particle size ranging from about 200 to about 300 microns.

21. The method of claim 17 where the liquid grinding aid is selected from the group consisting of a blend of at least one glycol selected from the group consisting of ethylene glycol, propylene glycol, diethylene glycol, dipropylene glycol, methyl ethers of such glycols, and mixtures thereof, and at least one other liquid selected from the group consisting of water and at least one alcohol, the alcohol being selected from the group consisting of methanol, ethanol, butanol, isopropanol, hexanol, heptanol, octanol and mixtures thereof.

22. The method of claim 17 where the two processors are oriented vertically one over the other.

23. The method of claim 17 where not all of the intermediate particulate polyolefin drag reducing agent of a first size from the first processor is fed to the second processor, and at least part of the diverted intermediate particulate polyolefin drag reducing agent of a first size is combined with at least part of the particulate polyolefin drag reducing agent of a second size to give a bi-modal or multi-modal drag reducing agent product.

24. The method of claim 17 further comprising feeding a solid grinding aid to the first processor.

25. A method for producing a particulate polymer drag reducing agent, comprising:
feeding to a first processor components comprising:
granulated polyolefin; and
at least one liquid grinding aid, where the first processor has an impeller; and
grinding the components to produce intermediate particulate polyolefin drag reducing agent of a first average particle size between about 550 to about 450 microns;
feeding to a second processor the intermediate particulate polyolefin drag reducing agent of a first size, where the second processor has an impeller, where the impeller of the first processor is relatively more open than the impeller of the second processor; and
grinding the components to produce the particulate polyolefin drag reducing agent of a second average particle size ranging from about 200 to about 300 microns suitable for reducing drag in flowing hydrocarbons,
where the grinding by both processors is conducted in the absence of cryogenic temperatures.

26. The method of claim 25 where the processors each grind the polyolefin using a combination of at least one rotor having the blades and at least one stator.

27. The method of claim 25 where particulate polyolefin drag reducing agent is not recycled to either processor.

28. The method of claim 25 where the liquid grinding aid is selected from the group consisting of a blend of at least one glycol selected from the group consisting of ethylene glycol, propylene glycol, diethylene glycol, dipropylene glycol, methyl ethers of such glycols, and mixtures thereof, and at least one other liquid selected from the group consisting of water and at least one alcohol, the alcohol being selected from the group consisting of methanol, ethanol, butanol, isopropanol, hexanol, heptanol, octanol and mixtures thereof.

29. The method of claim 25 where not all of the intermediate particulate polyolefin drag reducing agent of a first size from the first processor is fed to the second processor, and at least part of the diverted intermediate particulate polyolefin drag reducing agent of a first size is combined with at least part of the particulate polyolefin drag reducing agent of a second size to give a bi-modal or multi-modal drag reducing agent product.

30. The method of claim 25 further comprising feeding the particulate polyolefin drag reducing agent to at least one subsequent processor and grinding the particulate polyolefin drag reducing agent to a third size smaller than the second size.
